(19) United States
(12) Patent Application Publication
(10) Pub. No.: US 2022/0371141 A1
(43) Pub. Date: Nov. 24, 2022

(54) PROCESSING DEVICE FOR PROCESSING ONE OR MORE WORKPIECES

(71) Applicant: TRUMPF Werkzeugmaschinen SE + Co. KG, Ditzingen (DE)

(72) Inventors: Stephan Hochreiter, Linz (AT); Thomas Reiter, Sankt Marienkirchen (AT)

(21) Appl. No.: 17/873,197

(22) Filed: Jul. 26, 2022

Related U.S. Application Data
(63) Continuation of application No. PCT/EP2021/051821, filed on Jan. 27, 2021.

(30) Foreign Application Priority Data
Jan. 27, 2020 (AT) A50060/2020

(51) Int. Cl. B23Q 11/08; B23Q 39/02

(52) U.S. Cl. CPC B23Q 11/0825; B23Q 11/0891; B23Q 39/028

(57) ABSTRACT

A processing device for processing a workpiece includes a workpiece support, a working region extending over the workpiece support and having a first working zone and a second working zone, a processing tool and a divider comprising at least one adjustable element and moveable between a first position and a second position. In the first position, the divider separates the second working zone from the first working zone and, in the second position, the first working zone and the second working zone form a connected, continuous working region.

### CROSS REFERENCE TO RELATED APPLICATIONS

This application is a continuation of International Application No. PCT/EP2021/051821 (WO 2021/151924 A1), filed on Jan. 27, 2021, and claims benefit to Austrian Patent Application No. A50060/2020, filed on Jan. 27, 2020. The aforementioned applications are hereby incorporated by reference herein.

### FIELD

The invention relates to a processing device for processing one or more workpieces, in particular a welding device, preferably in the form of a welding cell and a method for processing, in particular welding, one or more workpieces.

### BACKGROUND

U.S. Pat. No. 9,114,474B2 discloses a work cell in which welding procedures are carried out by means of a welding robot. In this case, a first working zone and a second working zone are separated from one another. The welding robot is located between the working zones, and in each case separated from the working zones by shields. The drawback of such a system is that the size of a workpiece to be processed is limited to the size of a working zone. Not least, such systems are inflexible as a result and are only suitable for a predefined workpiece size. Additionally, the accessibility to the working zones is limited.

EP1840448A1 discloses a variable protective booth for the pendulum processing of workpieces. In this case, the walls of the protective booth are correspondingly positioned in a variable manner in the outermost processing positions, taking into account a safety distance from the processing tools. Such a construction requires a significant amount of space and due to the many wall elements which have to be repeatedly repositioned is very prone to error.

### SUMMARY

In an embodiment, the present disclosure provides a processing device for processing a workpiece. The processing device includes a workpiece support, a working region extending over the workpiece support and having a first working zone and a second working zone, a processing tool and a divider comprising at least one adjustable element and moveable between a first position and a second position. In the first position, the divider separates the second working zone from the first working zone and, in the second position, the first working zone and the second working zone form a connected, continuous working region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1, 2, 3, and 4 show an embodiment of a processing device in different positions of the divider and the shields;

FIG. 5 shows in a schematic view the controller of the processing device with the operating device and the activated components;

FIG. 6 shows an embodiment of a divider; and

FIG. 7 shows the workpiece support with the first and second working zone and the movable base point of the kinematics from above.

### DETAILED DESCRIPTION

It was the object of the present invention to remedy the drawbacks of the prior art and to provide a device and a method by which a user is not only able to permit pendulum processing but is also able to carry out the processing of larger workpieces, if required. The accessibility to the working zones is intended to be improved and the operation, in particular the set-up and removal of the workpieces, is intended to be facilitated. At the same time, a high degree of safety for the operator is intended to be ensured.

This object is achieved by a device mentioned in the introduction, in that, in the first position, the divider separates the second working zone from the first working zone and in that, in the second position of the divider, the first working zone and the second zone form a connected, continuous working region.

As the first and the second working zone form a connected, continuous working region, the processing device can also be used for processing workpieces which are larger than a working zone. By using the divider in its first position separating the working zones, a shuttle operation with preparation parallel to the main time is possible. In this case, the divider forms a protective shield relative to the working zone in which a processing of a workpiece is currently being carried out. If the divider is moved into its second position, whereby the working zones are connected together and form a continuous working region, larger workpieces are also able to be processed.

It is preferred if, in the second position of the divider, the region between the first working zone and the second working zone is an available space, preferably a space free of obstacles, over the entire extent of the workpiece support.

The divider can protect the operator (in the case of a parallel set-up) not only from the light of a welding tool but also from particles produced during processing.

Preferably, the width of the divider is at least as great as the width of the workpiece support (wherein the width of the divider and the width of the workpiece support are measured in the same direction of extension). As a result, a reliable shielding is ensured between the first and second working zone.

The workpiece support is preferably formed by the table surface of a table.

The processing device is preferably a welding device or a welding cell and the processing tool is a welding tool. In this case, all possible variants are conceivable, for example a device or a tool for light arc welding, oxyacetylene welding, laser welding, electron beam welding, welding as a joining method or build-up welding, etc.

However, other processing tools might also be conceivable in connection with the present invention, for example abrasive (for example drilling, milling or blasting tools), cutting (for example sawing or laser beam tools), joining (for example welding or soldering tools) or coating tools.

A preferred embodiment is characterized in that the processing device is configured in the form of a processing cell which is preferably enclosed on all sides and/or can be enclosed on all sides.

A preferred embodiment is characterized in that in the first position the divider forms a preferably vertical partition wall. As a result, a space-saving and structurally simple solution is achieved.

A preferred embodiment is characterized in that the divider is formed from at least two, preferably at least three, preferably telescopable, wall elements which can be moved relative to one another, wherein the wall elements are preferably connected together by means of guides. The space requirement is further reduced by this measure, since in the second position the divider only takes up a small amount of space.

A preferred embodiment is characterized in that in the first position of the divider the vertical spacing between the lower end of the divider and the workpiece support is at most 10 cm, preferably at most 5 cm, particularly preferably at most 3 cm, or the lower end of the divider bears against the workpiece support. In this manner—except for a possible small adjoining gap above the workpiece support—a complete shielding is made possible.

A preferred embodiment is characterized in that in the second position of the divider the vertical spacing between the lower end of the divider and the workpiece support is at least 50 cm, preferably at least 100 cm. As a result, sufficient vertical free space is also provided in the region between the first and second working zone, which permits optimal accessibility to the workpiece support (for example in the case of large workpieces).

A preferred embodiment is characterized in that the divider can be extended downwardly from the second position into the first position and can be retracted upwardly from the first position into the second position. In this manner, the workpiece support can be designed to be continuous—even between the first and second zones.

A preferred embodiment is characterized in that the divider is fastened in a suspended manner and/or in that the divider is fastened to a frame above the working region, in the region between the first and the second working zone. As a result, the workpiece support or the working region can be completely available, i.e. neither fastening points nor a “parked position” for the divider have to be taken into consideration in the region of the workpiece support.

A preferred embodiment is characterized in that the divider can be moved between the first and second position by at least one drive connected to a controller, wherein the at least one drive is preferably integrated in the uppermost wall element. This permits a fully automatic and thus also a reliable operation relative to safety aspects.

A preferred embodiment is characterized in that the workpiece support is configured to be continuous in the region between the first working zone and the second working zone.

A preferred embodiment is characterized in that the workpiece support is formed by a platform, preferably in the form of a plate, in particular a perforated plate or a plate with fastening structures for the workpiece.

A preferred embodiment is characterized in that the processing device comprises in front of the first working zone a first shield which can be moved between an open position and a closed position, preferably in the form of a partition wall, and which in the closed position shields a region outside the working region from the first working zone and in the open position makes the first working zone accessible from a region outside the working region, and/or in that the processing device comprises in front of the second working zone a second shield which can be moved between an open position and a closed position, preferably in the form of a partition wall, and which in the closed position shields a region outside the working region from the second working zone and in the open position makes the second working zone accessible from a region outside the working region.

The shields protect an operator located outside the working region. The shields are preferably able to be opened and closed in each case by a drive (connected to the controller of the processing device). The shields are arranged in front of the workpiece support. The shields can be actuated separately or independently of one another and protect the operator.

A preferred embodiment is characterized in that the horizontal spacing of the shields from the workpiece support is at most 10 cm, preferably at most 5 cm, particularly preferably at most 3 cm.

A preferred embodiment is characterized in that the smallest horizontal spacing between the first and/or second shield (in its closed position) and the divider (in its first position) is at most 10 cm, preferably at most 5 cm, particularly preferably at most 3 cm. As a result, the working zones are safely delimited.

A preferred embodiment is characterized in that the first shield is formed from at least one, preferably at least two, adjustable, preferably rail-guided, wall element(s) and/or in that the second shield is formed from at least one, preferably at least two, adjustable, preferably rail-guided, wall element(s).

A preferred embodiment is characterized in that in the closed position the first shield forms a preferably vertical partition wall and/or in that in the closed position the second shield forms a preferably vertical partition wall.

A preferred embodiment is characterized in that the first adjustable shield and the second adjustable shield in their closed positions are arranged adjacent to one another and/or in that the first adjustable shield and the second adjustable shield extend substantially in the same plane. In this case, the shields form the front face (front) of the processing device. When the shields are open at the same time, workpieces which are larger than the length of a working zone can also be set up, (i.e. arranged on the workpiece support).

A preferred embodiment is characterized in that in the closed positions of the shields a gap is formed between the first shield and the second shield, and in its first position the divider runs from top to bottom in the region of the gap. Preferably, therefore, the space between the shields is free, whereby a continuous accessibility to the workpiece support is provided when the shields are open.

A preferred embodiment is characterized in that in its first position the divider extends substantially perpendicularly to the shields.

A preferred embodiment is characterized in that the processing device comprises an operating device which is connected to the controller of the processing device, wherein the operating device is preferably arranged in the region of the shields, wherein the operating device is preferably held by a carrier element which extends through the gap between the shields (formed in the open positions of the shields). As a result, the operation can take place immediately in front of the workpiece support.

A preferred embodiment is characterized in that the shields can be moved from below into the closed position and/or in that the shields in each case can be extended upwardly from the open position into the closed position and can be retracted downwardly from the closed position into the open position. As a result, not only a space-saving construction is achieved but the region below the workpiece support is also concealed by the shields, even in the open positions.

A preferred embodiment is characterized in that the processing tool can be moved between a first working zone and a second working zone, and/or in that the processing tool can be moved transversely, preferably substantially perpendicularly, to the plane in which the divider extends. The processing tool can be used for processing procedures in the first working zone and for processing procedures in the second working zone.

A preferred embodiment is characterized in that the processing tool is arranged at the end of a swivel arm kinematics or serial kinematics, wherein the base point of the kinematics is preferably arranged in the region behind the workpiece support. The arrangement of the base point in the region behind the workpiece support, i.e. on the side of the workpiece support opposing the first and second shield, ensures that the workpiece support, in particular also the region between the first and second working zone, remains free and is available for setting up workpieces.

A preferred embodiment is characterized in that the base point of the kinematics can be moved, preferably can be moved in a linear manner, along the workpiece support and/or transversely, preferably substantially perpendicularly, to the plane in which the divider extends, preferably by a drive connected to the controller of the processing device. As a result, the workpiece support remains free and an automatic operation is permitted.

A preferred embodiment is characterized in that when the shields are open and the divider is located in the second position, the entire workpiece support is continuously accessible from outside the working region. The entire working region is accessible from outside at once, i.e. without any obstacles.

The object is also achieved by a method for processing, in particular welding, one or more workpieces, comprising a processing device according to the invention.

A preferred embodiment is characterized in that, before a processing procedure which is to be carried out with the processing tool in the first working zone, the divider is moved from the second position into the first position and/or the first shield is moved into the closed position, wherein the second shield is preferably located in the open position during the processing procedure.

A preferred embodiment is characterized in that, after a processing procedure which has been carried out in the first working zone with the processing tool, the first shield is moved into the open position and the second shield is moved into the second position, and a processing procedure is carried out with the processing tool in the second working zone, wherein the divider preferably remains in the first position.

A preferred embodiment is characterized in that, before a processing procedure which is to be carried out in the first and/or second working zone, the first shield and the second shield in each case are moved into the closed position, wherein the divider is preferably located in the second position during the processing procedure.

A preferred embodiment is characterized in that, between two processing procedures the processing tool, preferably the base point of the kinematics bearing the processing tool, is moved between the first working zone and the second working zone.

For improved understanding of the invention, this is described in more detail with reference to the following figures.

By way of introduction, it should be mentioned that in the differently described embodiments the same parts are provided with the same reference numerals or the same component designations, wherein the disclosures contained in the entire description can be expediently assigned to the same parts with the same reference numerals or the same component designations. Moreover, the positional information selected in the description, such as for example top, bottom, to the side, etc., relates to the figure directly described and shown, and in the case of a change in position this positional information can be expediently assigned to the new position.

The exemplary embodiments show possible variants, wherein at this point it should be mentioned that the invention is not limited to the specifically shown variants thereof but rather various combinations of the individual variants with one another are also possible, and this possibility for variation lies within the capabilities of the person skilled in the art who is active in this technical field, due to the directive for technical actions by the present invention.

The scope is determined by the claims. The description and the drawings, however, are to be used to interpret the claims. Individual features or combinations of features from the different exemplary embodiments shown and described can represent separate inventive solutions. The separate solutions according to the invention can be derived from the description.

All of the specifications relative to value ranges in the present description are to be understood to mean that these value ranges encompass any and all of the sub-ranges thereof, for example the specification 1 to 10 is to be understood to mean that all of the sub-regions starting from the lower limit 1 and the upper limit 10 are encompassed thereby, i.e. all of the sub-regions start with a lower limit of 1 or more and end at an upper limit of 10 or less, for example 1 to 1.7 or 3.2 to 8.1 or 5.5 to 10.

For the sake of clarity, it should finally be mentioned that for greater understanding of the structure, in some cases elements are shown not to scale and/or larger and/or smaller in size.

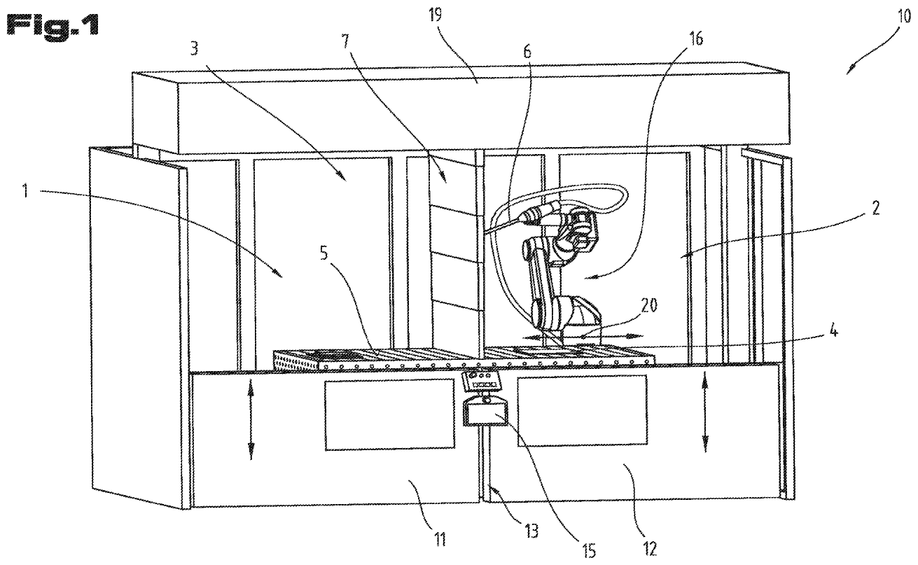

FIGS. 1 to 4 show a processing device 10 for processing one or more workpieces 4. The processing device 10 can be configured in the form of a welding cell—preferably enclosed by wall elements.

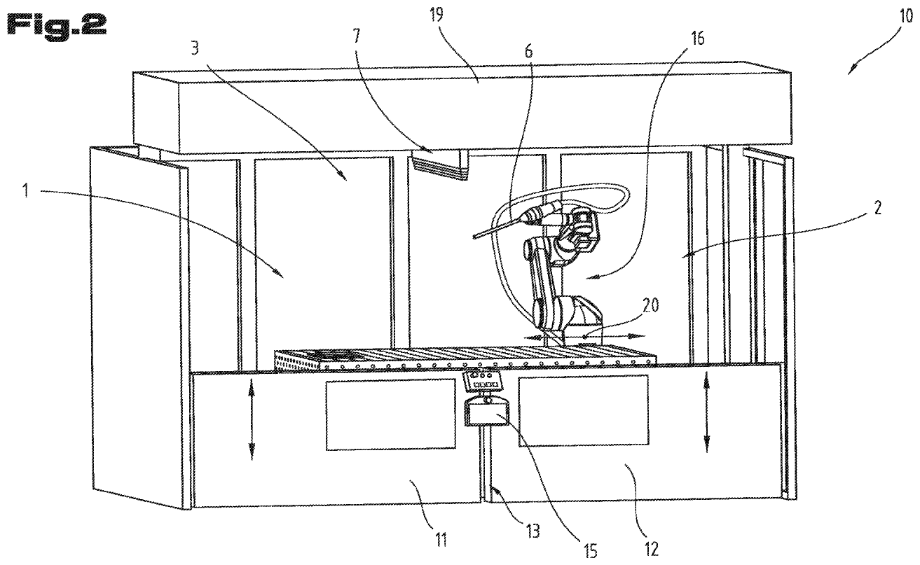

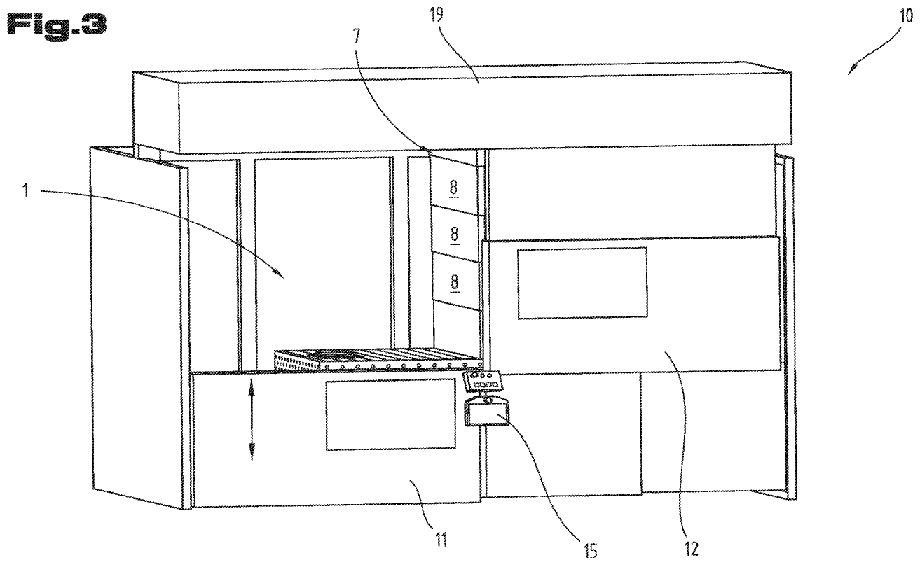

The processing device 10 comprises a workpiece support 5, a working region 3 extending over the workpiece support 5 and having a first working zone 1 and a second working zone 2, a processing tool 6 and a divider 7 which is formed by at least one adjustable element 8 and which can be moved between a first position (FIGS. 1 and 3) and a second position (FIG. 2).

In the first position, the divider 7 separates the second working zone 2 from the first working zone 1. In the second position of the divider 7, the first working zone 1 and the second working zone 2 form a connected, continuous working region 3 (FIG. 2).

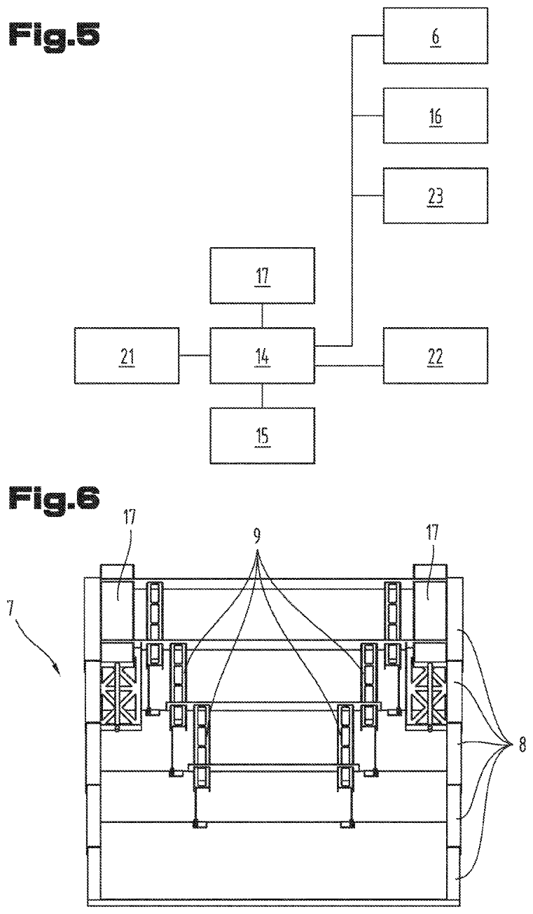

In the first position, the divider 7 forms a preferably vertical partition wall. In the embodiment shown, the divider 7 is formed from a plurality of (in this case telescopable) wall elements 8 which can be moved relative to one another. As shown in FIG. 6, the wall elements 8 can be connected to one another by means of guides 9. Thus a wall element can hold and also guide the wall element located therebelow. The drives 17 accommodated in the uppermost wall element act via the guides on the wall elements located therebelow, whereby the divider 7 can be retracted and extended.

It is preferred if, in the first position of the divider 7, the vertical spacing between the lower end of the divider 7 and the workpiece support 5 is at most 10 cm, preferably at most 5 cm, particularly preferably at most 3 cm (FIG. 1). As a result, a safe separation or shielding of the one working zone relative to the other working zone is ensured, whereby an operator, who sets up or removes workpieces in a working zone, is reliably protected from the processing tool located in the other working zone during operation. The lower end of the divider 7 can also bear against the workpiece support 5.

It is further preferred if, in the second position of the divider 7, the vertical spacing between the lower end of the divider 7 and the workpiece support 5 is at least 50 cm, preferably at least 100 cm (FIG. 2). As a result, an enlarged working region is produced for the operator without obstacles.

The divider 7 in FIGS. 1 to 4 can be extended downwardly from the second position into the first position and can be retracted upwardly from the first position into the second position. The divider 7 is fastened in a suspended manner to a frame 19 of the processing device 10 above the working region 3, in the region between the first working zone 1 and the second working zone 2.

The divider 7 can be moved between the first and second position (FIG. 5) by at least one drive 17 connected to a controller 14 of the processing device 10 (for example an electrical, hydraulic, pneumatic drive, linear drive and/or cylinder-piston drive). As already mentioned, the at least one drive 17 can be integrated in the uppermost wall element 8 (FIG. 6).

As can be seen in FIGS. 1 and 2, the workpiece support 5 is configured to be continuous in the region between the first working zone 1 and the second working zone 2. The workpiece support 5 of the embodiment shown is formed by a platform in the form of a plate (in this case a perforated plate). The holes serve for positioning the workpiece 4 or possible workpiece holders. Instead of holes, other fastening structures can also be provided on or in the plate.

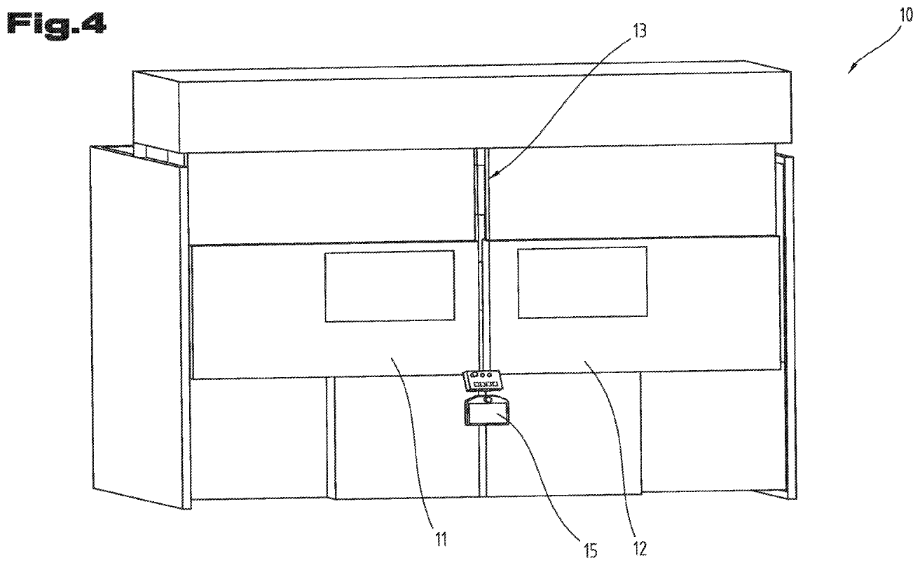

FIGS. 1 to 4 also show that the processing device 10 comprises in front of the first working zone 1 a first shield 11 which can be moved between an open position (FIGS. 1 to 3) and a closed position (FIG. 4), in this case in the form of a partition wall. The first shield 11 in its closed position shields a region outside the working region 3 (or a region in front of the workpiece support 5) from the first working zone 1 and in the open position makes the first working zone 1 accessible from a region outside the working region 3.

Furthermore, the processing device 10 comprises in front of the second working zone 2 a second shield 12 which can be moved between an open position (FIGS. 1 and 2) and a closed position (FIGS. 3 and 4), in this case in the form of a partition wall. The second shield in the closed position shields a region outside the working region 3 (or a region in front of the workpiece support 5) from the second working zone 2 and in the open position makes the second working zone 2 accessible from a region outside the working region 3.

The first shield 11 and the second shield 12 or the drives 21 and 22 thereof (FIG. 5) are controllable separately from one another. The drives 21 and 22 (controllable by the controller 14) move the respective shield 11, 12 between the closed and open position.

The first shield 11 and the second shield 12 in the embodiment shown in each case are formed from two adjustable (preferably rail-guided) wall elements. In each case, in the closed position they form a partition wall (which is in this case vertical).

The first shield 11 and the second shield 12 in their closed positions (in this case also in their open positions) are arranged adjacent to one another and extend substantially in the same plane (FIG. 4).

In the closed positions of the shields 11, 12 a gap 13 is formed between the first shield 11 and the second shield 12. In its first position, the divider 7 runs from top to bottom in the region of the gap 13. In its first (extended) position the divider 7 extends substantially perpendicularly to the shields 11, 12.

The processing device 10 can also comprise an operating device 15 which is connected to the controller 14. This operating device can be arranged in the region of the shields 11, 12. In a preferred embodiment, the operating device 15 can be held by a carrier element 18 which extends through the gap 13 between the shields 11, 12. The carrier element can be fastened, for example, to the workpiece support 5 or a frame carrying the workpiece support 5.

The shields 11, 12 of FIGS. 1 to 4 can be moved from below into the closed position or in each case can be extended upwardly from the open position into the closed position and can be retracted downwardly from the closed position into the open position.

As the double arrow in FIGS. 1, 2 and 5 indicates, the processing tool 6 can be moved between a first working zone 1 and a second working zone 2. In this case, the processing tool preferably can be moved transversely, preferably substantially perpendicularly, to the plane in which the divider 7 extends (in its first position).

The processing tool 6 is preferably arranged at the end of a swivel arm kinematics and/or serial kinematics 16. The base point 20 of the kinematics 16 in this case is preferably arranged in the region behind the workpiece support 5 (FIG. 5).

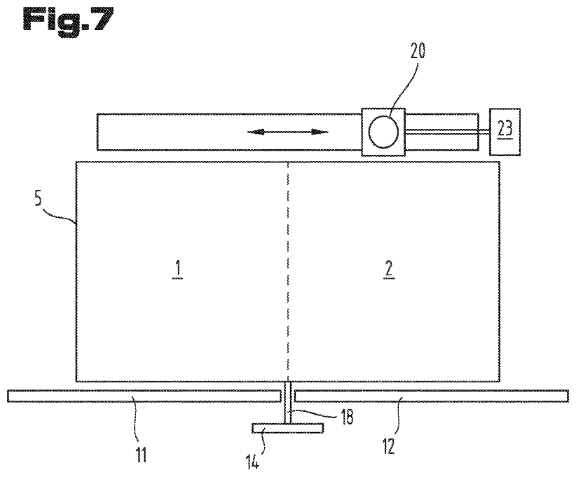

The base point 20 of the kinematics 16 can be moved (in this case can be moved in a linear manner) along the workpiece support 5 and transversely, preferably substantially perpendicularly, to the plane in which the divider 7 extends. This is brought about by a drive 23 connected to the controller 14 of the processing device 10 (FIGS. 5 and 7).

FIG. 2 finally shows that when the shields 11, 12 are open and the divider 7 is located in the second position, the workpiece support 5 is continuously accessible from outside the working region 3.

Preferred exemplary embodiments of a method for processing, in particular welding, one or more workpieces 4 comprising the processing device 10, are described hereinafter.

For example, before a processing procedure which is to be carried out by the processing tool 6 in the first working zone 1, the divider 7 can be moved from the second position into the first position and/or the first shield 11 can be moved into the closed position, wherein the second shield 12 is preferably located in the open position during the processing procedure.

After a processing procedure which has been carried out in the first working zone 1 with the processing tool 6, the first shield 11 can be moved into the open position and the second shield 12 can be moved into the closed position and a processing procedure can be carried out with the processing tool 6 in the second working zone 2, wherein the divider 7 preferably remains in its first (extended) position.

Before a processing procedure which is to be carried out in the first and/or second working zone 1, 2, the first shield 11 and the second shield 12 in each case can be moved into the closed position, wherein the divider 7 is preferably located in the second (retracted) position during the processing procedure. In this manner, the entire working space 3 can be utilized, for example in the case of very large workpieces.

Between two processing procedures, the processing tool 6, preferably the base point 20 of the kinematics 16 bearing the processing tool 6, can be moved between the first working zone 1 and the second working zone 2. As a result, a pendulum operation is permitted in which a further workpiece can be already set up in the respective other working zone.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 First working zone

2 Second working zone

3 Working region

4 Workpiece

5 Workpiece support

6 Processing tool

7 Divider

8 Wall element

9 Guides

10 Processing device

11 First shield

12 Second shield

13 Gap

14 Controller

15 Operating device

16 Kinematics

17 Drive

18 Carrier element

19 Frame

20 Base point

21 Drive of first shield 11

22 Drive of second shield 12

23 Drive

1. A processing device for processing a workpiece comprising:
a workpiece support;
a working region extending over the workpiece support and having a first working zone and a second working zone;
a processing tool; and
a divider comprising at least one adjustable element and moveable between a first position and a second position,
wherein, in the first position, the divider separates the second working zone from the first working zone and, in the second position, the first working zone and the second working zone form a connected, continuous working region.

2. The processing device as claimed in claim 1, wherein, in the first position, the divider forms a vertical partition wall.

3. The processing device as claimed in claim 1, wherein, in the first position, a vertical spacing between a lower end of the divider and the workpiece support is at most 10 cm,
and/or in the second position, the vertical spacing between the lower end of the divider and the workpiece support is at least 50 cm.

4. The processing device as claimed in claim 1, wherein the divider is extendable downwardly from the second position into the first position and is retractable upwardly from the first position into the second position.

5. The processing device as claimed in claim 1, wherein the divider is fastened to a frame of the processing device above the working region, between the first working zone and the second working zone.

6. The processing device as claimed in claim 1, further comprising a controller and a drive connected to the controller, and wherein the divider is moveable between the first and second position by the drive.

7. The processing device as claimed in claim 1, wherein the workpiece support is continuous in the region between the first working zone and the second working zone.

8. The processing device as claimed in claim 1, further comprising a first shield disposed in front of the first working zone and moveable between an open position and a closed position.

9. The processing device as claimed in claim 8, wherein the first shield is formed from one or more adjustable wall elements.

10. The processing device as claimed in claim 8, wherein, in the closed position, the first shield forms a vertical partition wall.

11. The processing device as claimed in claim 8, further comprising a second shield moveable between an open and a closed position and wherein the first shield and the second shield in their closed positions are arranged adjacent to one another.

12. The processing device as claimed in claim 11, wherein, in the closed positions of the first and second shields a gap is formed between the first shield and the second shield.

13. The processing device as claimed in claim 6, further comprising an operating device connected to the controller.

14. The processing device as claimed in claim 8, wherein the first and second shields are extendable upwardly from the open position into the closed position and can be retracted downwardly from the closed position into the open position.

15. The processing device as claimed in claim 1, wherein the processing tool is moveable between the first working zone and the second working zone.

16. The processing device as claimed in claim 1, wherein the processing tool is arranged on a swivel arm kinematics, wherein a base point of the kinematics is disposed behind the workpiece support.

17. The processing device as claimed in claim 16, wherein the base point is moveable along the workpiece support.

18. The processing device as claimed in claim 8, wherein, when the first and second shields are open and the divider is located in the second position, the workpiece support is continuously accessible from outside the working region.

19. A method for processing one or more workpieces, using the processing device as claimed in claim 1.

20. The method as claimed in claim 19, wherein, before a processing procedure which is to be carried out with the processing tool in the first working zone, the divider is moved from the second position into the first position.
